(19) United States
(12) Patent Application Publication
(10) Pub. No.: US 2006/0137453 A1
(43) Pub. Date: Jun. 29, 2006

(54) Sensing apparatus

(75) Inventors: Tsung-Ying Wu, Taoyuan Hsien (TW); Tai-Kang Shing, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/263,834

(22) Filed: Nov. 2, 2005

(30) Foreign Application Priority Data
Dec. 28, 2004 (TW) 93140886

(51) Int. Cl. G01H 13/00

(52) U.S. Cl. 73/581

(57) ABSTRACT

A sensing apparatus utilizing film bulk acoustic resonators (FBARs). The film bulk acoustic resonator has a bulk acoustic wave velocity (Vb) and a corresponding resonant frequency (f). When the FBAR is subjected to a force such as acceleration, g-force or an air pressure, the bulk acoustic wave velocity changes to obtain a frequency downshift (Δf) in response to deformation caused by the force. A magnitude of the force is then obtained by calculating the frequency downshift (Δf).

This Non-provisional application claims priority under U.S.C.§ 119(a) on Patent Application No(s). 093140886 filed in Taiwan, Republic of China on Dec. 28, 2004, the entire contents of which are hereby incorporated by reference.

### BACKGROUND

The invention relates to a sensing apparatus, and more specifically to a sensing apparatus utilizing film bulk acoustic resonators (FBARs).

With the growth of the biotechnology, biomedical gauges have been scaled down from conventional large-sized apparatuses to small portable home-based devices capable of fast operation. In addition, in terms of mechanical industries such as an automobile industry, conventional mechanical apparatuses have evolved into sophisticated fine-tuned systems including a plurality of sensors to improve integration of automobiles with comfort and security features for drivers and passengers. All these applications, however, require sophisticated and real-time sensors.

Surface acoustical wave (SAW) devices are not only used widely in communications but also in sensors. Fast and highly accurate measurement can be obtained by measuring the variation of real-time SAW devices with high sensitivity. Conventional SAW devices made of piezoelectric materials which are single crystal or bulk are characterized in their piezoelectric characteristics, they are, however, costly. Additionally, because of limitations in materials and manufacturing processes, the higher the operating frequency, the greater the energy attenuation. Consequently, SAW devices are not capable of operating in high frequency.

Moreover, conventional SAW devices require additional fabrication to be integrated into ordinary semiconductor components. Hence, the overall size is not reduced and the production cost and time are increased. Further, possible variations in characteristics of SAW devices also increase due to additional fabrication processes.

### SUMMARY

In view of the above, the present invention provides a sensing apparatus utilizing film bulk acoustic resonators (FBARs) with fast and highly accurate measurement characteristics and advantages such as small size, low production cost, low power consumption and being suitable for use in high operating frequency. Moreover, FBARs can be integrated with conventional semiconductor components into one single chip in a wafer manufacturing stage, whereby avoiding additional fabrication processes and variations in characteristics caused thereby.

According to one aspect of the invention, the sensing apparatus for measuring a force includes a film bulk acoustic resonator (FBAR) having a bulk acoustic wave velocity (Vb) and a corresponding resonant frequency (f). When the FBAR is subjected to the force, the bulk acoustic wave velocity and the resonant frequency change to obtain a frequency downshift (Δf) in response to deformation caused by the force, and a magnitude of the force is obtained by calculating the frequency downshift (Δf). The FBAR includes a pair of electrodes and a piezoelectric layer sandwiched therebetween. When a high-frequency voltage signal is inputted to one of the electrodes, a bulk acoustic wave having the Vb and the resonant frequency is formed and progresses between the electrodes. The high-frequency voltage signal is generated by an oscillating circuit which is electrically connected to one of the electrodes or a wireless transmitter whereas the high-frequency voltage signal is received by an antenna which is electrically connected to one of the electrodes. The antenna generates a signal corresponding to the frequency downshift (Δf) and transmits the signal to the wireless transmitter for calculating the magnitude of the force.

The force is acceleration, g-force or air pressure. The sensing apparatus is electrically connected to a frequency counter for obtaining the frequency downshift (Δf). There is an oscillator or an amplifier coupled between the sensing apparatus and the frequency counter for modulating the frequency downshift (Δf). The sensing apparatus is integrated into a semi-conductor chip in the wafer manufacturing stage and is manufactured by Microelectromechanical (MEMS) technology.

According to another aspect of the invention, a sensing apparatus includes an impedance sensor, a film bulk acoustic resonator (FBAR) electrically connected to the impedance sensor, and a matching circuit for adjusting the impedance between the FBAR and the impedance sensor, wherein the sensitivity of the impedance sensor is increased by a high operating frequency of the FBAR. The impedance sensor is operative to measure an air pressure, such as the tire pressure of a motor vehicle, or measure an acceleration caused by the torsion of a spinning object.

The FBAR includes a pair of electrodes and a piezoelectric layer sandwiched therebetween. When a high-frequency voltage signal is inputted to one of the electrodes, a bulk acoustic wave having the Vb and the resonant frequency is formed to progress between the electrodes. Alternatively, the FBAR includes at least two piezoelectric layers and a plurality of electrodes for providing more variations of the FBAR connection. The piezoelectric layer is made of AlN, ZnO, PZT or BaTiO₃. Further, the impedance sensor and the FBAR are integrated into a semi-conductor chip in the wafer manufacturing stage and the sensing apparatus is manufactured by Microelectromechanical (MEMS) technology.

According to another aspect of the invention, a sensing apparatus including a film bulk acoustic resonator (FBAR) having a bulk acoustic wave velocity (Vb) and a corresponding resonant frequency (f), and a chemical or biochemical sensitive substance disposed on the FBAR. If a tested object reacts with the chemical or biochemical sensitive substance, the weight of the chemical or biochemical sensitive substance is changed, and the force is generated. Thus, the chemical or biochemical characteristic of the tested object is obtained.

The FBAR includes a pair of electrodes and a piezoelectric layer sandwiched therebetween. When a high-frequency voltage signal is inputted to one of the electrodes, a bulk acoustic wave, having the Vb and the resonant frequency (F), is formed to progress between the electrodes. The high-frequency voltage signal is generated by an oscillating circuit which is electrically connected to one of the electrodes or a wireless transmitter whereas the high-frequency voltage signal is received by an antenna which is electrically connected to one of the electrodes. The antenna further generates and transmits a signal corresponding to the frequency downshift (Δf) to the wireless transmitter for obtaining the chemical or biochemical characteristics of the tested object. The piezoelectric layer is made of AlN, ZnO, PZT or BaTiO₃.

The sensing apparatus is electrically connected to a frequency counter for obtaining the frequency downshift (Δf), wherein an oscillator or an amplifier is coupled between the sensing apparatus and the frequency counter for modulating the frequency downshift (Δf). The sensing apparatus is integrated into a semi-conductor chip in the wafer manufacturing stage and manufactured by Microelectromechanical (MEMS) technology.

### DESCRIPTION OF THE DRAWINGS

The invention will be described by way of exemplary embodiments, but not limitations, illustrated in the accompanying drawings in which like references denote similar elements, and in which:

FIG. 1A is a schematic diagram of a thin film bulk acoustic resonator (FBAR) of the invention.

FIG. 1B is a schematic diagram showing that the FBAR in FIG. 1A is subjected to a force.

FIGS. 2A and 2B are block diagrams of sensing apparatuss according to the first embodiment of the invention.

FIG. 2C is a block diagram showing the sensing apparatus with a wireless transmitter according to the first embodiment of the invention.

FIG. 3A is a schematic diagram of a sensing apparatus according to the second embodiment of the invention.

FIG. 3B is a schematic diagram of another sensing apparatus according to the second embodiment of the invention.

### DETAILED DESCRIPTION

The invention provides a sensing apparatus utilizing FBARs which have advantages such as low production cost, power consumption and being suitable for use in high operating frequency (up to 10 GHz) in order to improve the testing characteristics of the sensing apparatus. The operation of FBARs is described in the following.

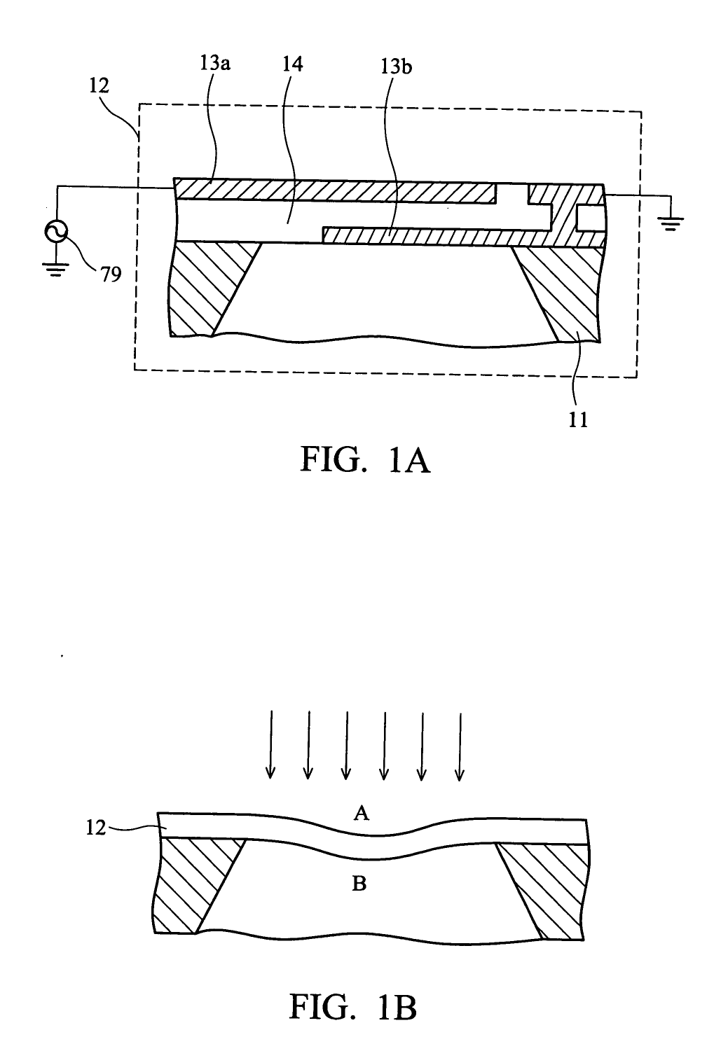

FIG. 1A is a FBAR according to an embodiment of the invention. The FBAR 12 includes a pair of electrodes 13a and 13b, and a piezoelectric layer 14 sandwiched between the electrodes 13a and 13b. The FBAR 12 is formed on a substrate 11 having deformation capability and, the electrode 13a is electrically connected to an oscillating circuit 79.

When the oscillating circuit 79 generates a high-frequency voltage signal to the FBAR 12 via the electrode 13a, a bulk acoustic wave is excited because of the piezoelectric effect to progress between the upper electrode 13a and lower electrode 13b. Because of the boundary reflection, the transmission of the acoustic wave becomes a standing wave resonance, wherein an equation relating to the resonant frequency, the bulk acoustic wave velocity, and the piezoelectric thin film thickness thereof is as follows.
F=Vb/(2*t);

wherein f is the resonant frequency, Vb is the bulk acoustic wave velocity and t is the thickness of the piezoelectric layer 14.

Thus, when one of the electrodes of the FBAR 12 receives a high-frequency voltage signal, a bulk wave is generated to progress between electrodes 13a and 13b. As the results, a bulk acoustic wave velocity (Vb) and a corresponding resonant frequency (f) of the bulk wave are abtained.

FIG. 1B shows that the FBAR of FIG. 1A is subjected to a force. When the pressure of A is greater than that of B, the FBAR 12 is deformed due to the force, as shown in FIG. 1B. Because of the deformation of the FBAR 12, the bulk acoustic wave velocity (Vb) changes and the resonant frequency (f) changes accordingly. Therefore, the magnitude of the pressure of A can be then obtained by calculating the frequency downshift (Δf).

In addition, the FBAR is deformed because of not only uneven surrounding air pressure but also acceleration or g-force. In order to enable those skilled in the art to practice the invention, embodiments according to the invention with the described principle of the FBAR are described in the following.

### FIRST EMBODIMENT

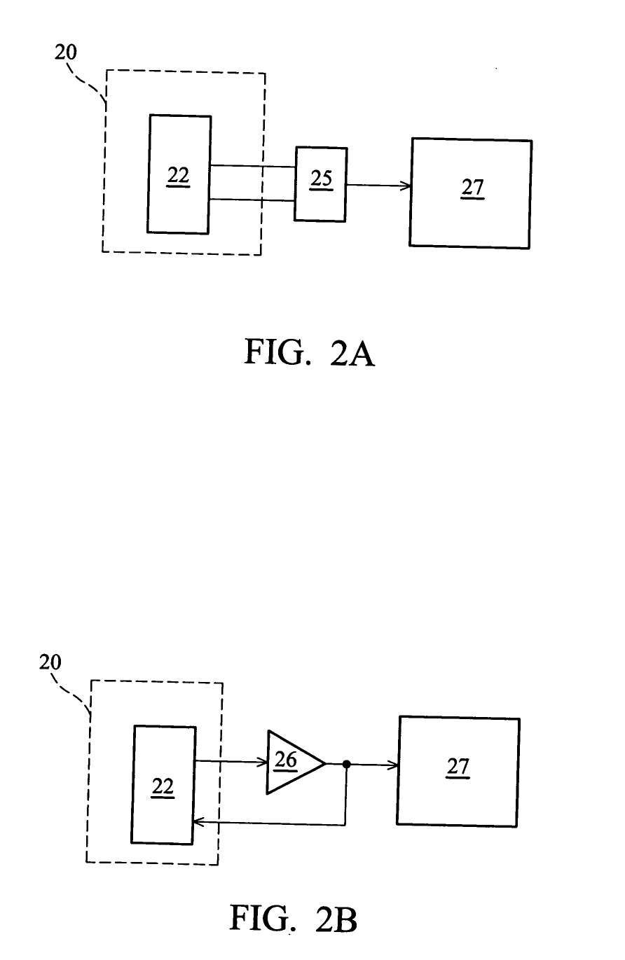

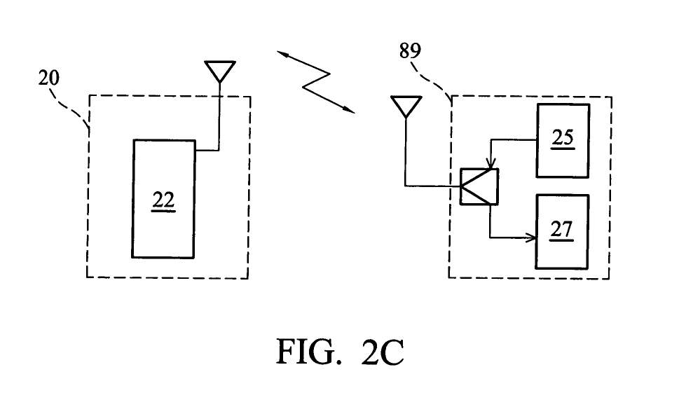

FIGS. 2A and 2B are schematic diagrams of a sensing apparatus according to the first embodiment of the invention. The sensing apparatus 20 according to the first embodiment of the invention includes a FBAR 22 coupled to an oscillating circuit for receiving a high-frequency voltage signal. The sensing apparatus 20 is further electrically connected to a frequency counter 27. Also, there is further an oscillator 25 (as shown in FIG. 2A) or an amplifier 26 (as shown in FIG. 2B) coupled between the sensing apparatus 20 and the frequency counter 27.

The FBAR 22 has a bulk acoustic wave velocity (Vb) and a corresponding resonant frequency (f). When the FBAR 20 is subjected to a force, FBAR 12 is deformed, and the bulk acoustic wave velocity (Vb) changes, and then the resonant frequency (f) changes accordingly. After modulation of the oscillator 25 or the amplifier 26, the magnitude of the force can be obtained by calculating the frequency downshift (Δf) by using the frequency counter 27.

Additionally, the high-frequency voltage signal can be provided to the FBAR 22 either by wired or wireless transmission. Referring to FIG. 2C, which is a block diagram showing a sensing apparatus with wireless transmitter according to the first embodiment of the invention. The sensing apparatus 20 receives the high-frequency voltage signal via an antenna and a feedback signal corresponding to Δf is generated thereby to a transmitter 89. The high-frequency voltage signal is provided by the transmitter 89 and received via the antenna coupled to the electrodes of the FBAR 22.

Moreover, the magnitude of the force can be obtained by calculating the signal corresponding to Δf received by the transmitter 89 by using the frequency counter 27.

### SECOND EMBODIMENT

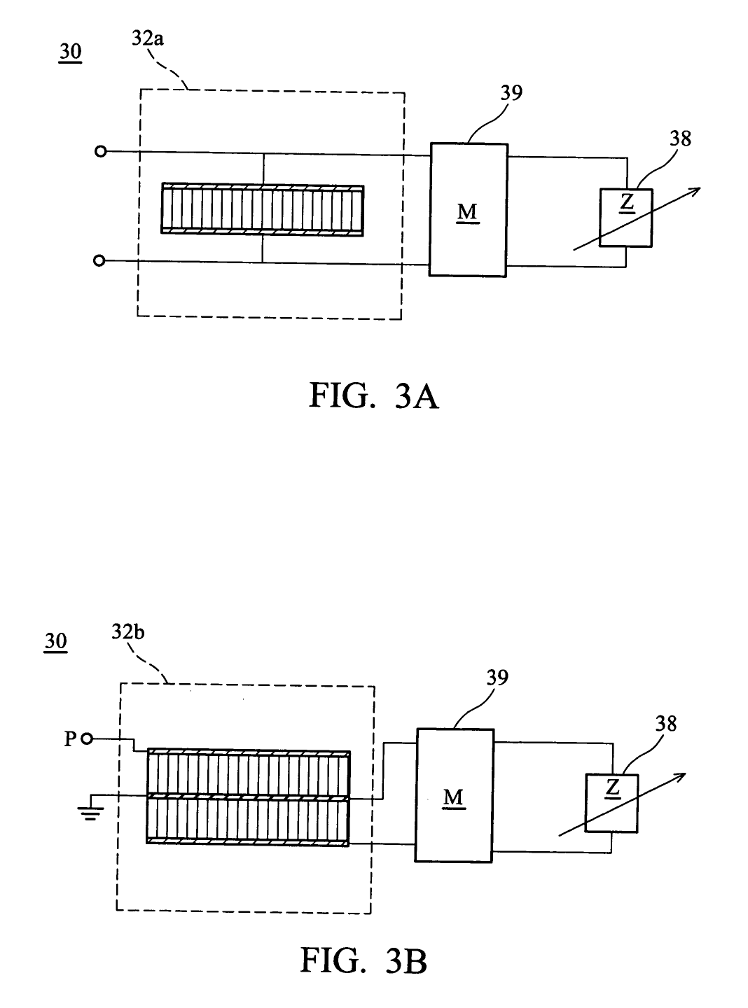

The first embodiment utilizes the FBAR 22 to obtain the magnitude of the force, which can also be obtained by coupling the FBAR to an impedance sensor in parallel or in series. Because the resonant frequency changes in response to the input impendence of the impedance sensor, the force can be obtained by detecting the resonant frequency of the FBAR. Referring to FIG. 3A, which shows a sensing apparatus according to the second embodiment of the invention. The sensing apparatus 30 includes an impedance sensor 38, a FBAR 32a, and a matching circuit 39. The FBAR 32a is electrically connected to the impedance sensor 38, and the matching circuit 39 is used to adjust the impedance between the FBAR 32a and the impedance sensor 38, wherein the matching circuit 39 also provides a better coupling effect between the FBAR 32a and the impedance sensor 38.

The sensitivity of the impedance sensor 38, such as a capacitance or resistive pressure sensor, can be improved by the high operating frequency of the FBAR 32a. Moreover, the impedance sensor 38 is capable of detecting an air pressure, such as the tire pressure of a motor vehicle or an acceleration caused by the torsion of a spinning object.

The FBAR 32a, which is similar to the FBAR 22 according to the first embodiment of the invention, includes a pair of electrodes and a piezoelectric layer sandwiched therebetween. When a high-frequency voltage signal is inputted to one of the electrodes, a bulk acoustic wave having a buck acoustic wave velocity (Vb) and the corresponding resonant frequency (f) is formed to progress between the electrodes.

Alternatively, a two-port FBAR can also be employed. Referring to FIG. 3B, which shows another sensing apparatus according to the second embodiment of the invention. The FBAR 32b includes at least two piezoelectric layers and a plurality of electrodes. The FBAR 32b is electrically connected to the impedance sensor 38, and the impedance between the FBAR 32b and the impedance sensor 38 is adjusted by the matching circuit 39. The matching circuit 39 also provides a better coupling effect between the FBAR 32b and the impedance sensor 38.

With reference to FIG. 3B, the electrode of the lower piezoelectric layer in the FBAR 32b, having two piezoelectric layers, is electrically connected to the impedance sensor 38, so that the impendence of the first port P of the FBAR 32b is changed, and the resonant frequency measured by the first port P is also changed accordingly. This provides more flexibility in connection of the FBAR. Thus, a best connection way regarding different impedance sensors can be adopted according to different impendence of the impedance sensors so as to achieve best measure sensitivity.

Both the FBARs 32a and 32b improve the sensitivity of the sensing apparatus 30 and the FBARs 32a and 32b can be integrated into a chip with impedance sensors manufactured by Microelectromechanical (MEMS) technology, such as Pressure Gauges, Accelerometers and the like, to reduce the production cost, simplify fabrication and achieve miniaturization.

### THIRD EMBODIMENT

The first and second embodiments utilize the deformation characteristic of forced FBARs. The FBAR, however, can also be utilized for a chemical or biochemical sensors. The sensing apparatus of the third embodiment includes a FBAR and a chemical or biochemical sensitive substance. The FBAR has a bulk acoustic wave velocity (Vb) and a corresponding resonant frequency (f). The chemical or biochemical sensitive substance is disposed on the FBAR by deposition, coating or other equivalent methods. If a tested object reacts with the sensitive substance, the tested object will combine with the sensitive substance, transform the sensitive substance, or make the sensitive substance to fall off, so that the weight of the sensitive substance is then changed, which consequently changes the loading on the surface of the FBAR. Thus, the bulk acoustic velocity (Vb) then changes, resulting in a shift of the resonant frequency (f), called a frequency downshift (if). Therefore, the chemical or biochemical characteristic of the tested object is obtained. Conversely, if the frequency downshift (Δf) is zero, it means the tested object does not have this chemical or biochemical characteristic. In addition, different chemical or biochemical sensitive substances can be coated on the surface of the FBAR according to different chemical or biochemical characteristics of the tested object.

Moreover, the sensing apparatus of the third embodiment can also utilize the wireless transmitter disclosed in the first embodiment to detect the resonant frequency of the FBAR. Because this is a passive detection which does not need additional power supply, disadvantages of active sensing apparatuses, such as limited battery life, and additional weight, size and production cost, are then eliminated. Moreover, using FBARs is also preferred for their advantages such as higher Q value than SAW devices', low power consumption and the same production cost but with higher operating frequency. Therefore, take a wireless passive sensor used in the 2.4 GHz ISM band as the example, a sensing apparatus with a FBAR is the first choice.

Further, the above-described sensing apparatuses can be manufactured by Microelectromechanical (MEMS) technology and the FBAR disposed on a silicon substrate can be integrated into a semiconductor chip in wafer manufacturing stage, avoiding additional fabrication and thus reducing production cost, simplifying the manufacturing process and achieving miniaturization.

In conclusion, the sensing apparatuses disclosed in the present invention utilizing a film bulk acoustic resonator (FBAR) manufactured with a piezoelectric thin film by MEMS technology. The sensing apparatuses have fast and highly accurate measurement characteristics and also have advantages such as small size, low production cost, low power consumption, and being suitable for use in high operating frequency (up to 10 GHz). Moreover, the FBAR can be integrated into one single chip with conventional semiconductor components, whereby reducing production cost, simplifying fabrication and achieving miniaturization. The variation of characteristics caused by additional processes is thus avoided.

While the invention has been described by way of example and in terms of preferred embodiment, it is to be understood that the invention is not limited thereto. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A sensing apparatus for measuring a force, comprising:
a film bulk acoustic resonator (FBAR) having a bulk acoustic wave velocity (Vb) and a corresponding resonant frequency (f);
wherein when the FBAR is subjected to the force, the bulk acoustic wave velocity and the resonant frequency change to obtain a frequency downshift (Δf) in response to deformation caused by the force, and a magnitude of the force is obtained by calculating the frequency downshift.

2. The sensing apparatus of claim 1, wherein the film bulk acoustic resonator comprises a pair of electrodes and a piezoelectric layer sandwiched therebetween, wherein when a high-frequency voltage signal is inputted to one of the electrodes, a bulk acoustic wave, having the bulk acoustic wave velocity and the resonant frequency, is formed to progress between the electrodes.

3. The sensing apparatus of claim 2, wherein the high-frequency voltage signal is generated by an oscillating circuit which is electrically connected to one of the electrodes.

4. The sensing apparatus of claim 2, wherein the high-frequency voltage signal is generated by a wireless transmitter and received by an antenna which is electrically connected to one of the electrodes.

5. The sensing apparatus of claim 4, wherein the antenna generates and transmits a signal corresponding to the frequency downshift (Δf) to the wireless transmitter for calculating the magnitude of the force.

6. The sensing apparatus of claim 2, wherein the piezoelectric layer comprises material of AlN, ZnO, PZT or BaTiO₃.

7. The sensing apparatus of claim 1, wherein the force is acceleration, g-force or an air pressure.

8. The sensing apparatus of claim 1, wherein the sensing apparatus is electrically connected to a frequency counter for obtaining the frequency downshift (Δf).

9. The sensing apparatus of claim 8, wherein an oscillator or an amplifier is coupled between the sensing apparatus and the frequency counter for modulating the frequency downshift (Δf).

10. The sensing apparatus of claim 1, wherein the sensing apparatus is integrated into a semi-conductor chip in the wafer manufacturing stage, or the sensing apparatus is manufactured by Microelectromechanical (MEMS) technology.

11. The sensing apparatus of claim 1, further comprising an impedance sensor electrically connected to the film bulk acoustic resonator, wherein a sensitivity of the impedance sensor is increased by a high operating frequency of the film bulk acoustic resonator.

12. The sensing apparatus of claim 11, further comprising a matching circuit coupled between the film bulk acoustic resonator and the impedance sensor for adjusting an impedance between the film bulk acoustic resonator and the impedance sensor.

13. The sensing apparatus of claim 11, wherein the impedance sensor measures an air pressure or a tire pressure of a motor vehicle.

14. The sensing apparatus of claim 11, wherein the impedance sensor is operative to measure an acceleration, and the acceleration is caused by a torsion of a spinning object.

15. The sensing apparatus of claim 11, wherein the impedance sensor and the film bulk acoustic resonator are integrated into a semi-conductor chip in the wafer manufacturing stage.

16. The sensing apparatus of claim 1, further comprising a chemical or biochemical sensitive substance disposed on the film bulk acoustic resonator, wherein if a tested object reacts with the chemical or biochemical sensitive substance, a weight of the chemical or biochemical sensitive substance is changed, and the force is generated so as to obtain chemical or biochemical characteristics of the tested object.

17. The sensing apparatus of claim 16, wherein the high-frequency voltage signal is generated by a wireless transmitter and received by an antenna which is electrically connected to one of the electrodes.

18. The sensing apparatus of claim 17, wherein the antenna generates and transmits a signal corresponding to the frequency downshift (Δf) to the wireless transmitter for deriving the chemical or biochemical characteristics of the tested object.

19. A sensing apparatus comprising:
an impedance sensor;
a film bulk acoustic resonator (FBAR) electrically connected to the impedance sensor; and
a matching circuit for adjusting an impedance between the film bulk acoustic resonator and the impedance sensor;
wherein the sensitivity of the impedance sensor is increased by a high operating frequency of the film bulk acoustic resonator.

20. A sensing apparatus comprising:
a film bulk acoustic resonator (FBAR) having a bulk acoustic wave velocity (Vb) and a corresponding resonant frequency (f); and
a chemical or biochemical sensitive substance disposed on the film bulk acoustic resonator;
wherein if a tested object reacts with the chemical or biochemical sensitive substance, a weight of the chemical or biochemical sensitive substance is changed, and the force is generated so as to obtain chemical or biochemical characteristics of the tested object.
